(19) United States
(12) Patent Application Publication
(10) Pub. No.: US 2026/0102787 A1
(43) Pub. Date: Apr. 16, 2026

(54) HOUSING AND ELECTRONIC DEVICE COMPRISING SAME

(71) Applicant: SAMSUNG ELECTRONICS CO., LTD., Suwon-si (KR)

(72) Inventors: Taehyun SONG, Suwon-si (KR); Jongwan JEONG, Suwon-si (KR)

(21) Appl. No.: 19/418,434

(22) Filed: Dec. 12, 2025

Related U.S. Application Data
(63) Continuation of application No. PCT/KR2024/007083, filed on May 24, 2024.

(30) Foreign Application Priority Data
Jun. 12, 2023 (KR) 10-2023-0075149
Sep. 13, 2023 (KR) 10-2023-0121637

(51) Int. Cl. B05D 5/06; B05D 7/00; H04M 1/02

(52) U.S. Cl. CPC B05D 5/065; B05D 7/58; H04M 1/0203

(57) ABSTRACT

An electronic device comprising a housing. The housing includes a first area having a first reflectivity and a second area having a second reflectivity different from the first reflectivity. The first area includes a substrate, a first optical coating layer disposed on the substrate, a photon absorption layer disposed on the first optical coating layer, and a second optical coating layer disposed on the photon absorption layer. The second area includes the substrate and the first optical coating layer. The first optical coating layer is formed by alternately stacking a first material having a first refractive index and a second material having a second refractive index, which is different from the first refractive index. The second optical coating layer is formed by alternately stacking a third material having a third refractive index and a fourth material having a fourth refractive index, which is different from the third refractive index.

### CROSS-REFERENCE TO RELATED APPLICATIONS

This application is a continuation of International Application No. PCT/KR2024/007083, designating the United States, filed on May 24, 2024, in the Intellectual Property Receiving Office and claiming priority to Korean Patent Application No. 10-2023-0075149 and Korean Patent Application No. 10-2023-0121637, which were filed in the Korean Intellectual Property Office on Jun. 12, 2023 and Sep. 13, 2023, respectively, the entire disclosure of each of which is incorporated herein by reference.

### TECHNICAL FIELD

An embodiment of the disclosure relates to an electronic device including a housing and a method of processing a housing.

### BACKGROUND ART

Advancing information communication technologies and semiconductor technologies accelerate the spread and use of various electronic devices. In particular, recent electronic devices are being designed to facilitate communication while being carried.

The term “electronic device” may refer to a device performing a particular function according to its equipped program, such as a home appliance, an electronic scheduler, a portable multimedia player, a mobile communication terminal, a tablet PC, a video/sound device, a desktop PC or laptop computer, a navigation for automobile, or the like. For example, the electronic devices may output stored information in the form of audio or video. As electronic devices are highly integrated, and ultra-high-speed, high-volume wireless communication becomes commonplace, an electronic device, such as a mobile communication terminal, is recently being equipped with various functions. For example, an electronic device comes with the integrated functionality, including an entertainment function, such as playing video games, a multimedia function, such as replaying music/videos, a communication and security function for mobile banking, and a scheduling or e-wallet function. These electronic devices have been downsized to be conveniently carried by users. As the carrying and use of compact and slim mobile devices, e.g., smartphones, become commonplace, users may demand more sophisticated and diversified exterior designs for mobile devices.

The above-described information may be provided as related art for the purpose of helping understanding of the disclosure. No claim or determination is made as to whether any of the foregoing is applicable as background art in relation to the disclosure.

### DETAILED DESCRIPTION OF THE INVENTION

### Technical Solution

An electronic device including a housing according to an embodiment of the disclosure may include the housing having a first area having a first reflectivity and a second area having a second reflectivity different from the first reflectivity. The first area includes a substrate, a first optical coating layer disposed on the substrate, a photon absorption layer disposed on the first optical coating layer, and a second optical coating layer disposed on the photon absorption layer. The second area includes the substrate and the first optical coating layer. The first optical coating layer is configured such that a first material having a first refractive index and a second material having a second refractive index different from the first refractive index are alternatively stacked. The second optical coating layer is configured such that a third material having a third refractive index and a fourth material having a fourth refractive index different from the third refractive index are alternatively stacked.

An electronic device including a housing according to an embodiment of the disclosure may include the housing having a substrate, a plurality of optical coating layers disposed on the substrate, and a photon absorption layer disposed between a first optical coating layer and a second optical coating layer constituting the plurality of optical coating layers. The housing may include a first area including the substrate, the first optical coating layer, the photon absorption layer, and the second optical coating layer and having a first reflectivity, and a second area excluding at least a portion from the first area and having a second reflectivity different from the first reflectivity.

A method of processing a housing including a first area and a second area having different reflectivities according to an embodiment of the disclosure includes a first vapor deposition process forming a first optical coating layer on a substrate, a second vapor deposition process forming a photon absorption layer on the first optical coating layer, a third vapor deposition process forming a second optical coating layer on the photon absorption layer, and a selective etching process removing the photon absorption layer and the second optical coating layer from the second area of the housing, wherein the selective etching process radiates a laser of a specific wavelength to the second area.

### BRIEF DESCRIPTION OF DRAWINGS

FIG. 1 is a block diagram illustrating an electronic device in a network environment according to an embodiment of the disclosure.

FIG. 2 is a front perspective view illustrating an electronic device according to an embodiment of the disclosure.

FIG. 3 is a perspective view illustrating the back of an electronic device according to an embodiment of the disclosure.

FIG. 4A is an exploded perspective view illustrating an electronic device illustrating the front according to an embodiment of the disclosure.

FIG. 4B is an exploded perspective view illustrating an electronic device illustrating the back according to an embodiment of the disclosure.

FIG. 5 is a cross-sectional view schematically illustrating a portion of a first area of a housing cut along line A-A′ of the electronic device of FIG. 3 according to an embodiment of the disclosure.

FIG. 6 is a cross-sectional view illustrating a first area and a second area of a housing according to an embodiment of the disclosure.

FIG. 7 is a cross-sectional view illustrating a first area of a housing according to an embodiment of the disclosure.

FIG. 8 is a cross-sectional view illustrating a housing including a protective coating layer according to an embodiment of the disclosure.

FIG. 9 is a view illustrating a processing method of a housing including a first area and a second area having different reflectivities according to an embodiment of the disclosure.

FIG. 10 is a view illustrating irradiation of a laser according to a selective etching process on a housing according to an embodiment of the disclosure.

FIGS. 11 and 12 are photos illustrating a difference between a first area and a second area of a housing according to an embodiment of the disclosure.

FIG. 13 illustrates an experimental example of laser irradiation according to a selective etching process on a second area of a housing and an enlarged cross-sectional photo according to an embodiment of the disclosure.

FIG. 14 is a cross-sectional photo illustrating a difference between a first area and a second area of a housing according to an embodiment of the disclosure.

FIG. 15 is a cross-sectional view illustrating at least a portion of a housing according to an embodiment of the disclosure.

FIG. 16 is a cross-sectional view illustrating at least a portion of a housing according to an embodiment of the disclosure.

FIG. 17 is a cross-sectional view illustrating at least a portion of a housing according to an embodiment of the disclosure.

### MODE FOR CARRYING OUT THE INVENTION

The electronic device according to embodiments of the disclosure may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

An embodiment of the disclosure and terms used therein are not intended to limit the technical features described in the disclosure to specific embodiments, and should be understood to include various modifications, equivalents, or substitutes of the embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

It will be understood that when an element is referred to as being “on” another element, it can be directly on the other element or intervening elements may be present therebetween. In contrast, when an element is referred to as being “directly on” another element, there are no intervening elements present.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. Therefore, reference to “an” element in a claim followed by reference to “the” element is inclusive of one element as well as a plurality of the elements.

“At least one” is not to be construed as limiting “a” or “an.” “Or” means “and/or.” As used herein, the term “and/or” includes any and all combinations of one or more of the associated listed items.

It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program) including one or more instructions that are stored in a storage medium (e.g., internal memory or external memory) that is readable by a machine (e.g., the electronic device 101). For example, a processor (e.g., the processor) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Here, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to an embodiment, each component (e.g., a module or a program) of the above-described components may include a single entity or multiple entities. Some of the plurality of entities may be separately disposed in different components. According to an embodiment, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

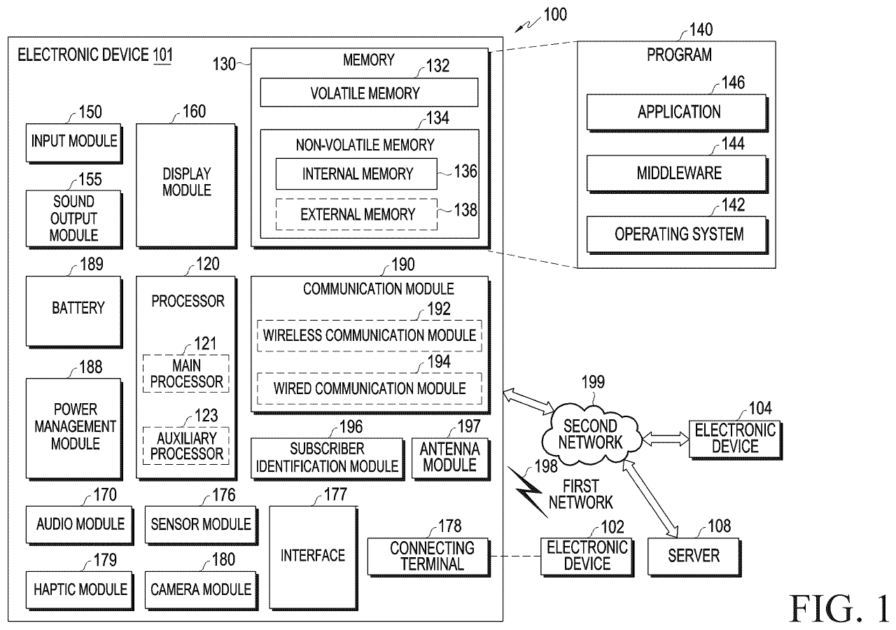

FIG. 1 is a block diagram illustrating an electronic device in a network environment according to an embodiment of the disclosure;

Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment, at least one (e.g., the connecting terminal 178) of the components may be omitted from the electronic device 101, or one or more other components may be added in the electronic device 101. In an embodiment, some (e.g., the sensor module 176, the camera module 180, or the antenna module 197) of the components may be integrated into a single component (e.g., the display module 160).

The processor 120 may execute, for example, software (e.g., the program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display 160 may include, for example, a display, a hologram device, or a projector and control circuitry to control a corresponding one of the display, hologram device, and projector. According to an embodiment, the display module 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operation state (e.g., power or temperature) of the electronic device 101 or an external environmental state (e.g., the user's state), and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wiredly) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via a first network 198 (e.g., a short-range communication network, such as Bluetooth™, wireless-fidelity (Wi-Fi) direct, or infrared data association (IrDA)) or a second network 199 (e.g., a long-range communication network, such as a legacy cellular network, a 5G network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). According to an embodiment, the antenna module 197 may include one antenna including a radiator formed of a conductor or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

According to an embodiment, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, instructions or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

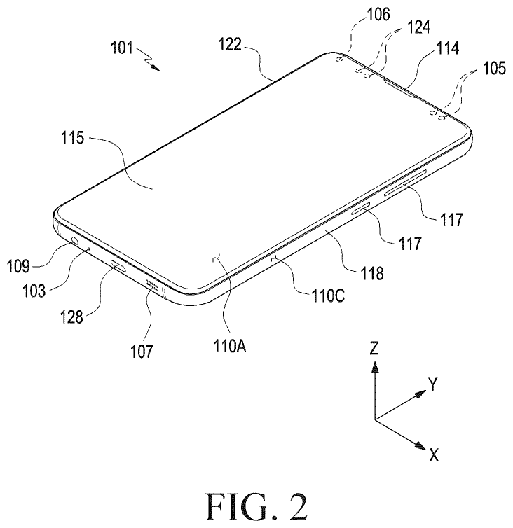

FIG. 2 is a front perspective view illustrating an electronic device 101 according to an embodiment of the disclosure.

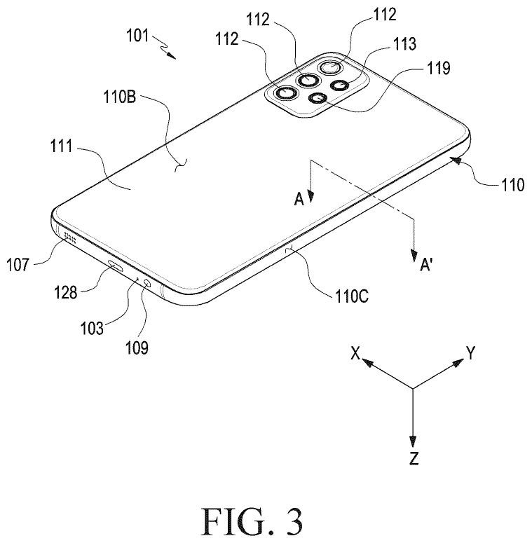

FIG. 3 is a rear perspective view illustrating an electronic device 101 according to an embodiment of the disclosure.

Referring to FIGS. 2 and 3, according to an embodiment, an electronic device 101 (e.g., the electronic device 101 of FIG. 1) may include a housing 110 including a first surface (or front surface) 110A, a second surface (or rear surface) 110B, and a side surface 110C surrounding a space between the first surface 110A and the second surface 110B. According to an embodiment (not shown), the housing 110 may denote a structure forming the first surface 110A of FIG. 2, the second surface 110B of FIG. 3, and some of the side surfaces 110C.

According to an embodiment, at least part of the first surface 110A may have a substantially transparent front plate 122 (e.g., a glass plate or polymer plate including various coat layers). The second surface 110B may be formed of a substantially opaque rear plate 111. The rear plate 111 may be formed of, e.g., laminated or colored glass, ceramic, polymer, metal (e.g., aluminum, stainless steel (STS), or magnesium), or a combination of at least two thereof. The side surface 110C may be formed by a side structure (or a “side bezel structure”) 118 that couples to the front plate 122 and the rear plate 111 and includes a metal and/or polymer. In an embodiment, the rear plate 111 and the side structure 118 may be integrally formed together and include the same material (e.g., a metal, such as aluminum).

According to an embodiment, the front plate 122 may include area(s) that bend from at least a portion of an edge toward the rear plate 111 and seamlessly extend. For example, only one of the areas of the front plate 122 (or the rear plate 111), which bend to the rear plate 111 (or front plate 122) and extend may be included in one edge of the first surface 110A. According to an embodiment, the front plate 122 or rear plate 111 may be substantially flat and, in this case, may not include an area bending and extending. When an area bending and extending is included in the front plate 122 or rear plate 111, the thickness of the electronic device 101 at the portion including the area bending and extending may be smaller than the thickness of the rest.

According to an embodiment, the electronic device 101 may include at least one of a display 115, an audio module (e.g., the microphone hole 103, the external speaker hole 107, and the phone receiver hole 114), a sensor module (e.g., the first sensor module 124, the second sensor module (not illustrated), or the third sensor module 119), a camera module (e.g., the first camera device 105, the second camera device 112, or the flash 113), a key input device 117, a light emitting device 106, and a connector hole (e.g., the first connector hole 128 or the second connector hole 109). In an embodiment, the electronic device 101 may exclude at least one (e.g., the key input device 117 or the light emitting device 106) of the components or may add other components.

The display 115 may output a screen or be visually exposed through a significant portion of the first surface 110A (e.g., the front plate 122), for example. In an embodiment, at least a portion of the display 115 may be visually exposed through the front plate 122 forming the first surface 110A, or through a portion of the side surface 110C. In an embodiment, the edge of the display 115 may be formed to be substantially the same in shape as an adjacent outer edge of the front plate 122. In an embodiment (not illustrated), the interval between the outer edge of the display 115 and the outer edge of the front plate 122 may remain substantially even to give a larger area of visual exposure of the display 115.

According to an embodiment, a recess or an opening may be formed in a portion of the screen display area of the display 115, and there may be included at least one of an audio module (e.g., the phone receiver hole 114), a sensor module (e.g., the first sensor module 124), a camera module (e.g., the first camera device 105), and a light emitting device 106 that are aligned with the recess or the opening. In an embodiment (not shown), at least one of the audio module (e.g., the phone receiver hole 114), sensor module (e.g., the first sensor module 124), camera module (e.g., the first camera device 105), fingerprint sensor (not shown), and light emitting device 106 may be included on the rear surface of the screen display area of the display 115. In an embodiment (not illustrated), the display 115 may be disposed to be coupled with, or adjacent, a touch detecting circuit, a pressure sensor capable of measuring the strength (pressure) of touches, and/or a digitizer for detecting a magnetic field-type stylus pen.

According to an embodiment, the audio modules 103, 107, and 114 may include a microphone hole 103 and speaker holes (e.g., the external speaker hole 107 and the phone receiver hole 114). A microphone for acquiring external sounds may be disposed in the microphone hole 103. In an embodiment, a plurality of microphones may be disposed to detect the direction of the sound. The speaker holes may include an external speaker hole 107 and a phone receiver hole 114. According to an embodiment, the speaker holes (e.g., the external speaker hole 107 and the phone receiver hole 114) and the microphone hole 103 may be implemented as a single hole, or speakers may be included without the speaker holes (e.g., the external speaker hole 107 and the phone receiver hole 114) (e.g., piezo speakers).

According to an embodiment, the sensor module may generate an electrical signal or data value corresponding to an internal operating state or external environmental state of the electronic device 101. The sensor modules may include a first sensor module 124 (e.g., a proximity sensor) and/or a second sensor module (not shown) (e.g., a fingerprint sensor) disposed on the first surface 110A of the housing 110 and/or a third sensor module 119 disposed on the second surface 110B of the housing 110. The second sensor module (not shown) (e.g., a fingerprint sensor) may be disposed on the second surface 110B or side surface 110C as well as the first surface 110A (e.g., the display 115) of the housing 110. The electronic device 101 may further include, e.g., at least one of a gesture sensor, a gyro sensor, an atmospheric pressure sensor, a magnetic sensor, an acceleration sensor, a grip sensor, a color sensor, an infrared (IR) sensor, a biometric sensor, a temperature sensor, a humidity sensor, or an illuminance sensor 124.

According to an embodiment, the camera modules may include a first camera device 105 disposed on the first surface 110A of the electronic device 101, and a second camera device 112 and/or a flash 113 disposed on the second surface 110B. The camera devices (e.g., the first camera device 105 and the second camera device 112) may include one or more lenses, an image sensor, and/or an image signal processor. The flash 113 may include, e.g., a light emitting diode or a xenon lamp. In an embodiment, one or more lenses (an infrared (IR) camera, a wide-angle lens, and a telephoto lens) and image sensors may be disposed on one surface of the electronic device 101. In an embodiment, flash 113 may emit infrared light. The infrared light emitted by the flash 113 and reflected by the subject may be received through the third sensor module 119. The electronic device 101 or the processor (e.g., the processor 120 of FIG. 1) of the electronic device 101 may detect depth information about the subject based on the time point when the infrared light is received from the third sensor module 119.

According to an embodiment, the key input device 117 may be disposed on the side surface 110C of the housing 110. In an embodiment, the electronic device 101 may exclude all or some of the above-mentioned key input devices 117 and the excluded key input devices 117 may be implemented in other forms, e.g., as soft keys, on the display 115. In an embodiment, the key input device may include the sensor module disposed on the second surface 110B of the housing 110.

According to an embodiment, the light emitting device 106 may be disposed on the first surface 110A of the housing 110, for example. The light emitting device 106 may provide, e.g., information about the state of the electronic device 101 in the form of light. In an embodiment, the light emitting device 106 may provide a light source that interacts with, e.g., the camera module (e.g., the first camera device 105). The light emitting device 106 may include, e.g., a light emitting diode (LED), an infrared (IR) LED, or a xenon lamp.

According to an embodiment, the connector holes (e.g., the first connector hole 128 or the second connector hole 109) may include, e.g., a first connector hole 128 for receiving a connector (e.g., a USB connector) for transmitting/receiving power and/or data to/from an external electronic device (e.g., the electronic device 102 of FIG. 1) and/or a second connector hole 109 (e.g., an earphone jack) for receiving a connector for transmitting/receiving audio signals to/from the external electronic device.

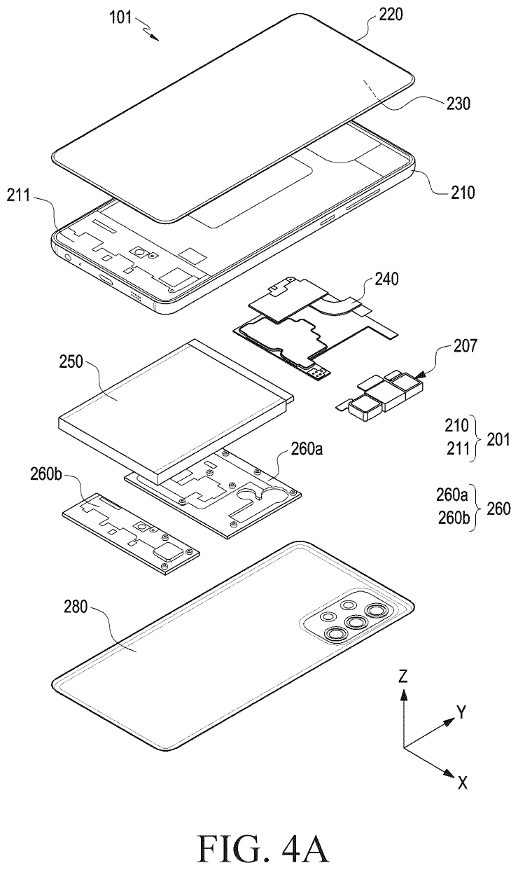

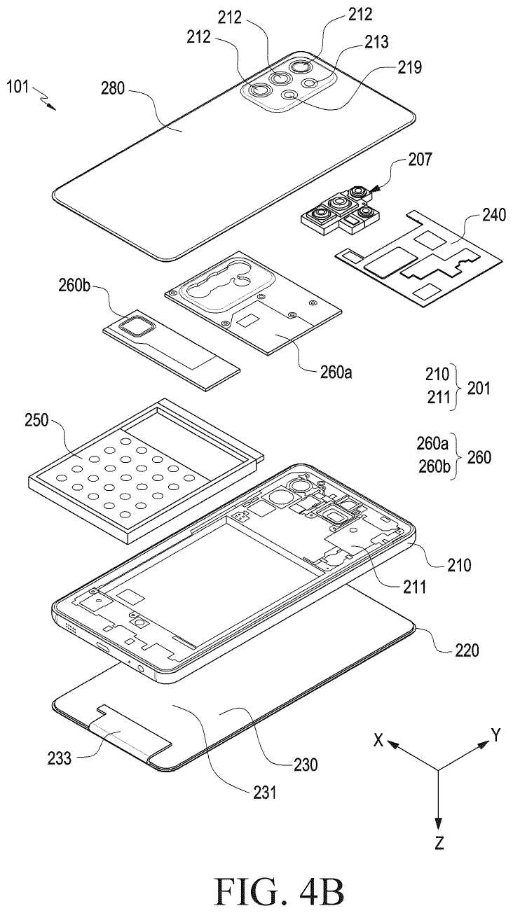

FIG. 4A is a front exploded perspective view illustrating an electronic device 101 according to an embodiment of the disclosure.

FIG. 4B is a rear exploded perspective view illustrating an electronic device 101 according to an embodiment of the disclosure.

Referring to FIGS. 4A and 4B, an electronic device 101 (e.g., the electronic device 101 of FIG. 1, 2, or 3) may include a side structure 210, a first supporting member 211 (e.g., a bracket), a front plate 220 (e.g., the front plate 122 of FIG. 2), a display 230 (e.g., the display 115 of FIGS. 2 and 3), a printed circuit board (or a board assembly) 240, a battery 250, a second supporting member 260 (e.g., a rear case), an antenna, a camera assembly 207, and a rear plate 280 (e.g., the rear plate 111 of FIG. 3).

According to an embodiment, the electronic device 101 may exclude at least one (e.g., the first supporting member 211 or the second supporting member 260) of the components or may add other components. At least one of the components of the electronic device 101 may be the same or similar to at least one of the components of the electronic device 101 of FIG. 2 or 3 and no duplicate description is made below.

According to an embodiment, the first supporting member 211 may be disposed inside the electronic device 101 to be connected with the side structure 210 or integrated with the side structure 210. The first supporting member 211 may be formed of, e.g., a metallic material and/or non-metallic material (e.g., polymer). When at least partially formed of a metallic material, a portion of the side structure 210 or the first supporting member 211 may function as an antenna. The display 230 may be joined onto one surface of the first supporting member 211, and the printed circuit board 240 may be joined onto the opposite surface of the first supporting member 211. A processor (e.g., the processor 120 of FIG. 1), memory (e.g., the memory 130 of FIG. 1), and/or an interface (e.g., the interface 177 of FIG. 1) may be mounted on the printed circuit board 240. The processor may include one or more of, e.g., a central processing unit, an application processor, a graphic processing device, an image signal processing, a sensor hub processor, or a communication processor.

According to an embodiment, the first supporting member 211 and the side structure 210 may be collectively referred to as a front case or a housing 201. According to an embodiment, the housing 201 may be generally understood as a structure for receiving, protecting, or disposing the printed circuit board 240 or the battery 250. In an embodiment, the housing 201 may be understood as including a structure that the user may visually or tactfully recognize from the outside of the electronic device 101, e.g., the side structure 210, the front plate 220, and/or the rear plate 280. In an embodiment, the ‘front or rear surface of the housing 201’ may mean the first surface 110A of FIG. 2 or the second surface 110B of FIG. 3. In an embodiment, the first supporting member 211 may be disposed between the front plate 220 (e.g., the first surface 110A of FIG. 2) and the rear plate 280 (e.g., the second surface 110B of FIG. 3) and may function as a structure for placing an electrical/electronic component, such as the printed circuit board 240 or the camera assembly 207.

According to an embodiment, the display 230 may include a display panel 231 and a flexible printed circuit board 233 extending from the display panel 231. It may be understood that the flexible printed circuit board 233 is, e.g., electrically connected to the display panel 231 while at least partially disposed on the rear surface of the display panel 231. In an embodiment, reference number ‘231’ may be understood as a protective sheet disposed on the rear surface of the display panel. For example, the protective sheet may be understood as a portion of the display panel 231 unless otherwise designated in the detailed description below. In an embodiment, the protective sheet may function as a cushioning structure that absorbs external force (e.g., a low-density elastic material, such as a sponge) or an electromagnetic shielding structure (e.g., a copper sheet (CU sheet)). According to an embodiment, the display 230 may be disposed on the inner surface of the front plate 220 and, by including a light emitting layer, output a screen through at least a portion of the front plate 220 or the first surface 110A of FIG. 2. As mentioned above, the display 230 may output substantially the entire area of the front plate 220 or the first surface 110A of FIG. 2.

According to an embodiment, the memory may include, e.g., a volatile or non-volatile memory.

According to an embodiment, the interface may include, e.g., a high definition multimedia interface (HDMI), a universal serial bus (USB) interface, a secure digital (SD) card interface, and/or an audio interface. The interface may electrically or physically connect, e.g., the electronic device 101 with an external electronic device and may include a USB connector, an SD card/multimedia card (MMC) connector, or an audio connector.

According to an embodiment, the second supporting member 260 may include, e.g., an upper supporting member 260a and a lower supporting member 260b. In an embodiment, the upper supporting member 260a, together with a portion of the first supporting member 211, may be disposed to surround the printed circuit board 240. A circuit device (e.g., a processor, a communication module, or memory) implemented in the form of an integrated circuit chip or various electrical/electronic components may be disposed on the printed circuit board 240. According to an embodiment, the printed circuit board 240 may receive an electromagnetic shielding environment from the upper supporting member 260a. In an embodiment, the lower supporting member 260b may be utilized as a structure in which electrical/electronic components, such as a speaker module and an interface (e.g., a USB connector, an SD card/MMC connector, or an audio connector) may be disposed. In an embodiment, electrical/electronic components, such as a speaker module and an interface (e.g., a USB connector, an SD card/MMC connector, or an audio connector) may be disposed on an additional printed circuit board (not shown). For example, the lower supporting member 260b, together with the other part of the first supporting member 211, may be disposed to surround the additional printed circuit board. A speaker module or interface disposed on an additional printed circuit board (not shown) or lower supporting member 260b may be disposed corresponding to the connector hole (e.g., the first connector hole 128 or the second connector hole 109) or the audio module (e.g., the microphone hole 103 or the speaker hole (e.g., the external speaker hole 107 or the phone receiver hole 114)) of FIG. 2.

According to an embodiment, the battery 250 may be a device for supplying power to at least one component of the electronic device 101. The battery 189 may include, e.g., a primary cell which is not rechargeable, a secondary cell which is rechargeable, or a fuel cell. At least a portion of the battery 250 may be disposed on substantially the same plane as the printed circuit board 240. The battery 250 may be integrally or detachably disposed inside the electronic device 101.

Although not shown, the antenna may include a conductor pattern implemented on the surface of the second supporting member 260 through, e.g., laser direct structuring. In an embodiment, the antenna may include a printed circuit pattern formed on the surface of the thin film. The thin film-type antenna may be disposed between the rear plate 280 and the battery 250. The antenna may include, e.g., a near-field communication (NFC) antenna, a wireless charging antenna, and/or a magnetic secure transmission (MST) antenna. The antenna may perform short-range communication with, e.g., an external device or may wirelessly transmit or receive power necessary for charging. In an embodiment of the present invention, another antenna structure may be formed by a portion or combination of the side structure 210 and/or the first supporting member 211.

According to an embodiment, the camera assembly 207 may include at least one camera module. Inside the electronic device 101, the camera assembly 207 may receive at least a portion of the light incident through the optical hole or the camera windows 212, 213, and 219. In an embodiment, the camera assembly 207 may be disposed on the first supporting member 211 in a position adjacent to the printed circuit board 240. In an embodiment, the camera module(s) of the camera assembly 207 may be generally aligned with either one of the camera windows 212, 213, and 219 and be a least partially surrounded by the second supporting member 260 (e.g., the upper supporting member 260a).

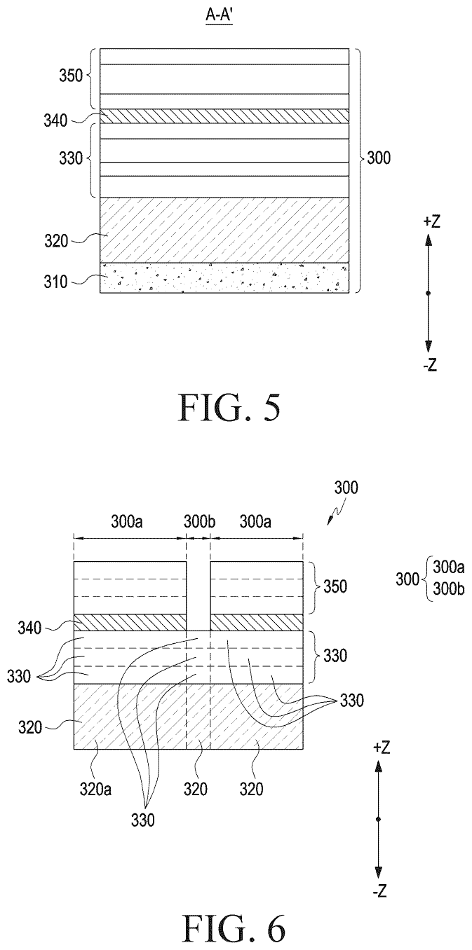

FIG. 5 is a cross-sectional view schematically illustrating a portion of a first area of a housing cut along line A-A′ of the electronic device of FIG. 3 according to an embodiment of the disclosure.

FIG. 6 is a cross-sectional view illustrating a first area 300a and a second area 300b of a housing 300 according to an embodiment of the disclosure.

Referring to FIGS. 5 and 6, a housing 300 of an electronic device 101 may include a base film 310, a substrate 320, a first optical coating layer 330, a photon absorption layer 340, and a second optical coating layer 350. The configuration of the housing 300 of FIGS. 5 and 6 may be identical in whole or portion to the configuration of the housing 201 of FIGS. 2 to 4. The structures of FIGS. 5 and 6 may be selectively combinable with the structures of FIGS. 2 to 4.

According to an embodiment, the housing 300 may include a substrate 320 to protect internal components of the electronic device (the electronic device 101 of FIG. 2) from external impacts. According to an embodiment, the substrate 320 may be a transparent material to allow light to pass through. According to an embodiment, the substrate 320 may be an amorphous substrate or a crystalline substrate. For example, the amorphous substrate 320 may be formed of glass, a polymer film, or polymer plastic, and the polymer film may include at least one of polyimide, polyethylene terephthalate (PET), or other polymer materials. For example, the crystalline substrate 320 may include at least one of sapphire, magnesium aluminate spinel (MgAl2O4), or silicon ingot. According to an embodiment, as the substrate 320 is optically transparent, aesthetic effects according to the color and/or texture of each of a plurality of layers constituting the housing 300 may be overlapped and appear in a composite manner.

According to an embodiment, the housing 300 may include a first optical coating layer 330 disposed on the substrate 320. According to an embodiment, the first optical coating layer 330 may be formed by alternately stacking two different materials having different refractive indices. In the process of light incident from outside passing through the first optical coating layer 330, constructive or destructive interference phenomena of wavelengths are manifested due to the difference in refractive index between different materials, and reflectivity or hue manifested by the constructive or destructive interference phenomena of wavelengths may be visually apparent to the outside. According to an embodiment, the first optical coating layer 330 may be a transparent material to allow light to pass through. According to an embodiment, the first optical coating layer 330 may be manufactured by a deposition method.

According to an embodiment, the housing 300 may include a second optical coating layer 350 disposed on the first optical coating layer 330. According to an embodiment, the second optical coating layer 350 may be formed by alternately stacking two different materials having different refractive indices. In the process of light incident from outside passing through the second optical coating layer 350, constructive or destructive interference phenomena of wavelengths are manifested due to the difference in refractive index between different materials, and reflectivity or hue manifested by the constructive or destructive interference phenomena of wavelengths may be visually apparent to the outside. According to an embodiment, the second optical coating layer 350 may be manufactured by a deposition method.

According to an embodiment, the housing 300 according to the disclosure may include a photon absorption layer 340 between the first optical coating layer 330 and the second optical coating layer 350 to facilitate delamination and/or removal of at least a portion of the first optical coating layer 330 and the second optical coating layer 350. The reason for including the photon absorption layer 340 between the first optical coating layer 330 and the second optical coating layer 350 is to selectively detach the second optical coating layer 350 together with the photon absorption layer 340 by having kinetic energy of photons radiated for selective delamination of the second optical coating layer 350 constituting the housing 300 react with the photon absorption layer 340 after being incident on the surface of the housing 300.

According to an embodiment, the photon absorption layer 340 may be a single layer. According to an embodiment, the photon absorption layer 340 may be in a compound form including nitrogen or oxygen to reduce the difference in refractive index between adjacent interfaces, since loss of incident light quantity should be minimal during medium transmission. According to an embodiment, the photon absorption layer 340 may be composed of a material having a low extinction coefficient (k). For example, the extinction coefficient (k) of the photon absorption layer 340 may be greater than or equal to 0.01 and less than or equal to 0.5. For example, the extinction coefficient (k) of the photon absorption layer 340 may be greater than or equal to 0.01 and less than or equal to 0.387.

According to an embodiment, the photon absorption layer 340 is composed of a single component and may be a transparent material to allow light to pass through. For example, the photon absorption layer 340 may be a silicon (Si) or aluminum (Al) based compound. For example, it may include at least one of optically transparent silicon or aluminum. According to an embodiment, a thickness of the photon absorption layer 340 may be greater than or equal to 10 nanometers (nm) and less than or equal to 500 nm. For example, when the thickness of the photon absorption layer 340 is 10 nm, substantially effective photon absorption may occur. For example, when the thickness of the photon absorption layer 340 is greater than or equal to 500 nm, optical distortion may occur, reducing the photon absorption effect.

According to an embodiment, the housing 300 may include a base film 310 exhibiting a specific color and gloss. For example, the base film 310 may include at least one of a film having anti-scatter properties or a color film configured to highlight design appearance. Referring to FIG. 5, the base film 310 may be disposed below the substrate 320, but the position of the base film is not limited thereto and may be variously modified in design. This is to aesthetically implement specific colors and gloss, and may be selectively removable according to colors and designs applied to the product.

According to an embodiment, the housing 300 may substantially correspond to the second surface (or the back surface (110B of FIG. 2) or the back plate (111 of FIG. 2)) of FIGS. 2 to 3. However, it is not limited to the back surface of the housing 300 according to FIGS. 2 to 3, and may be variously modified in design.

According to an embodiment, the housing 300 according to the disclosure may be formed to have two or more optical characteristics (e.g., reflectivity, color). According to an embodiment, the housing 300 may include a first area 300a having a first reflectivity and a second area 300b having a second reflectivity different from the first reflectivity. This is to configure an aesthetically beautiful housing 300 through two or more optical interference effects by implementing the housing 300 having two or more reflectivities.

According to an embodiment, the first area 300a may be formed by stacking the above-described substrate 320, the first optical coating layer 330, the photon absorption layer 340, and the second optical coating layer 350. According to an embodiment, the second area 300b may be an area where at least a portion of the housing 300 included in the first area 300a is removed. For example, the second area 300b may be composed of the above-described substrate 320 and the first optical coating layer 330, and the photon absorption layer 340 and the second optical coating layer 350 may be removed.

According to an embodiment, the first area 300a may implement a first reflectivity and a first color by optical characteristics manifested by the first optical coating layer 330 and the second optical coating layer 350. For example, the first reflectivity may be greater than or equal to 10%. For example, the first color may have a color coordinate value of 2 or more. Here, the color coordinate value may be defined as a color coordinate in CIELAB space. Color coordinates in CIELAB are denoted as L*, a*, b*, where L* may be three-dimensional coordinates representing brightness, a* the degree of red and green, and b* the degree of yellow and blue. The color coordinate value in CIELAB may be a value calculated as root (a*^2+b*^2), as the intensity of hue represented as a distance value from the origin on the CIELAB color coordinates.

Since the second optical coating layer 350 is removed from the second area 300b, a second reflectivity different from the first reflectivity and a second color different from the first color may appear due to optical characteristics manifested by the first optical coating layer 330. For example, the second reflectivity may differ from the first reflectivity by 2% or more. The second reflectivity may be dependent on the first reflectivity. For example, when the first reflectivity is 10%, the second reflectivity may be 0-8% or 12%-100%. For example, when the first reflectivity is 12%, the second reflectivity may be 0-10% or 14%-100%. For example, the second color may have a color coordinate value that differs from the first color by 2 or more. The second color may be dependent on the first color. For example, when the color coordinate value of the first color is 2, the color coordinate value of the second color may be 0 or less, or 4 or more. For example, when the color coordinate value of the first color is 4, the color coordinate value of the second color may be 2 or less, or 6 or more.

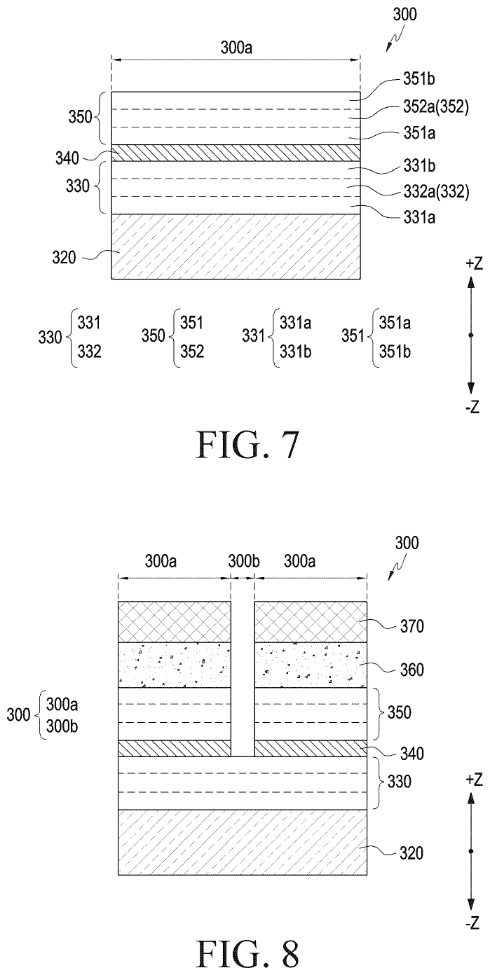

FIG. 7 is a cross-sectional view illustrating a first area 300a of a housing 300 according to an embodiment of the disclosure.

Referring to FIG. 7, a housing 300 of an electronic device 101 may include a substrate 320, a first optical coating layer 330, a photon absorption layer 340, and a second optical coating layer 350. The configuration of the housing 300 of FIG. 7 may be identical in whole or portion to the configuration of the housing 300 of FIGS. 2 to 6. The structure of FIG. 7 may be selectively combinable with the structures of FIGS. 5 to 6.

According to an embodiment, the first optical coating layer 330 may be formed by alternately stacking two different materials having different refractive indices. For example, the first optical coating layer 330 may be formed by alternately stacking a first material 331 having a first refractive index and a second material 332 having a second refractive index different from the first refractive index. For example, the first optical coating layer 330 may include a first material 331a having a first refractive index, a second material 332a having a second refractive index disposed on the first material 331a, and a first material 331b disposed on the second material 332a. For example, the first refractive index and the second refractive index may be about greater than or equal to 1.3 and less than or equal to 3.0. For example, the first refractive index may differ from the second refractive index by about 0.1 or more. For example, the first refractive index may be designed to be about 0.4 or more lower than the second refractive index. The optical characteristics of the first optical coating layer 330 may appear externally as reflection or hue manifested as constructive or destructive interference phenomena of wavelengths due to the difference in refractive index between different materials in the process of light incident from outside passing through the housing 300 including the optical coating structure according to the disclosure. According to FIG. 7, only the first area 300a is shown, but this is for convenience of description and may be equally applied to the second area 300b.

According to an embodiment, the second optical coating layer 350 may be formed by alternately stacking two different materials having different refractive indices. For example, the second optical coating layer 350 may be formed by alternately stacking a third material 351 having a third refractive index and a fourth material 352 having a fourth refractive index different from the third refractive index. For example, the second optical coating layer 350 may include a third material 351a having a third refractive index, a fourth material 352a having a fourth refractive index disposed on the third material 351a, and a third material 351b disposed on the fourth material 352a. For example, the third refractive index and the fourth refractive index may be about greater than or equal to 1.3 and less than or equal to 3.0. For example, the third refractive index may differ from the fourth refractive index by about 0.1 or more. For example, the third refractive index may be designed to be about 0.4 or more lower than the fourth refractive index. The optical characteristics of the second optical coating layer 350 may appear externally as reflection or hue manifested as constructive or destructive interference phenomena of wavelengths due to the difference in refractive index between different materials in the process of light incident from outside passing through the housing 300 including the optical coating structure according to the disclosure.

FIG. 8 is a cross-sectional view illustrating a housing 300 including protective coating layers 360, 370 according to an embodiment of the disclosure.

Referring to FIG. 8, a housing 300 of an electronic device 101 may include a substrate 320, a first optical coating layer 330, a photon absorption layer 340, a second optical coating layer 350, and protective coating layers 360, 370. The configuration of the housing 300 of FIG. 8 may be identical in whole or portion to the configuration of the housing 300 of FIGS. 2 to 7. The structure of FIG. 8 may be selectively combinable with the structures of FIGS. 5 to 7.

According to an embodiment, the housing 300 may further include protective coating layers 360, 370 on the second optical coating layer 350. For example, the housing 300 may further include a first protective coating layer 360 having high hardness on the second optical coating layer 350. For example, the housing 300 may further include a second protective coating layer 370 having stain resistance and/or scratch resistance to prevent or reduce contamination on the second optical coating layer 350. For example, the housing 300 may further include a first protective coating layer 360 on the second optical coating layer 350, and a second protective coating layer 360 on the first protective coating layer 360. Even when the housing 300 includes the first protective coating layer 360 and/or the second protective coating layer 370, selective delamination of the second area 300b may be possible because it includes the photon absorption layer.

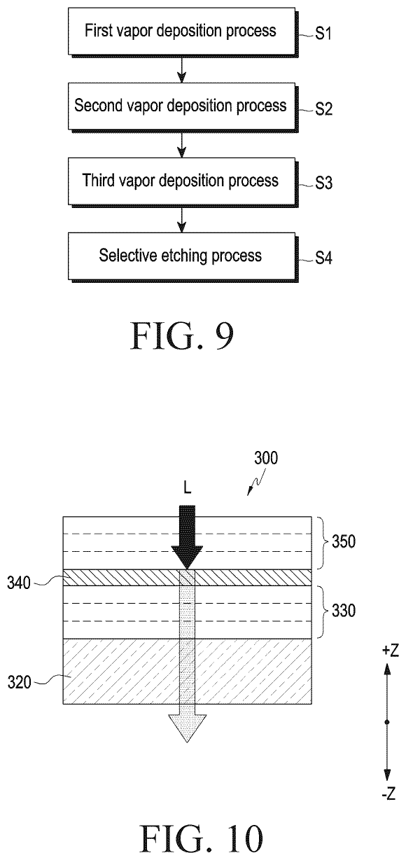

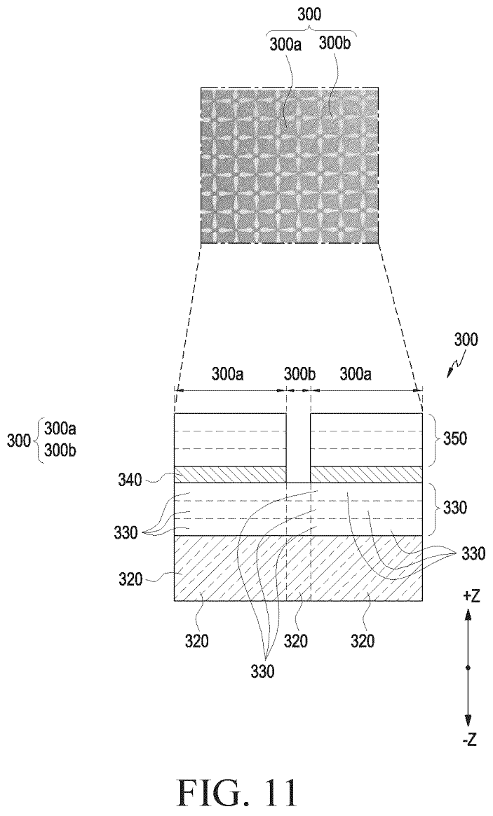

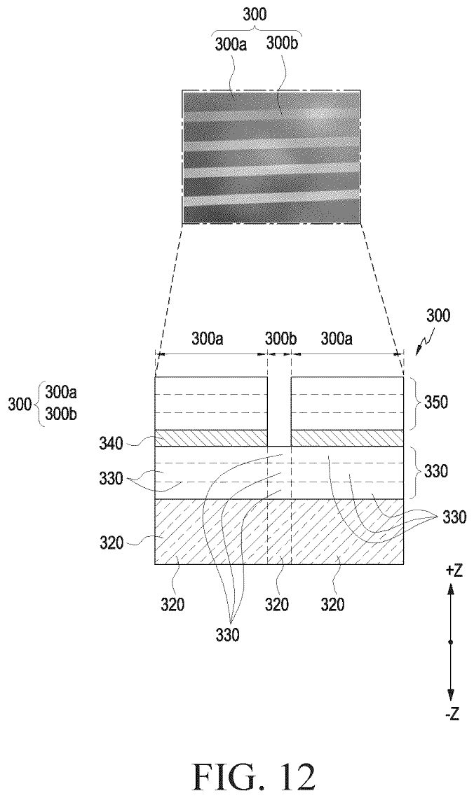

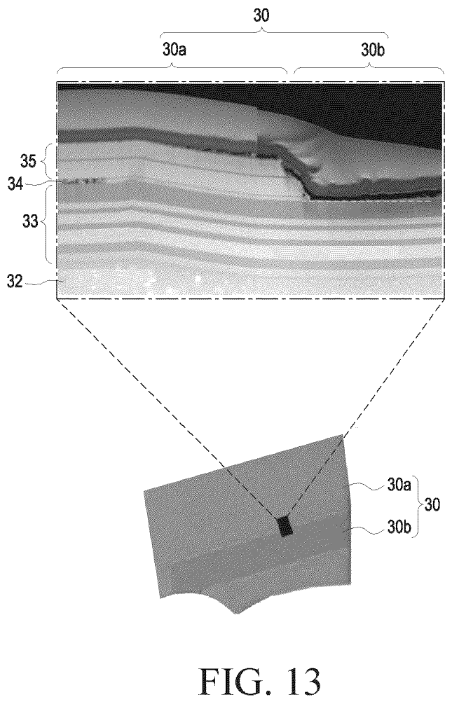

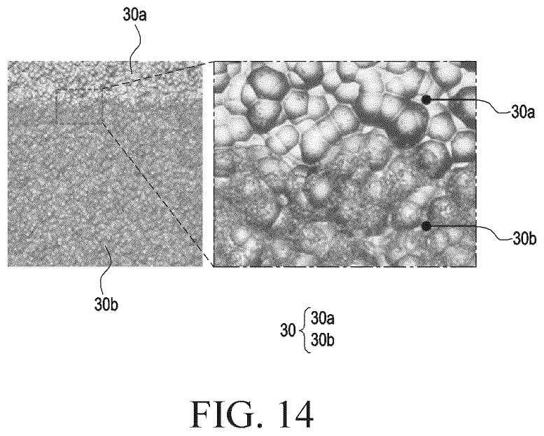

FIG. 9 is a view illustrating a processing method of a housing 300 including a first area 300a and a second area 300b having different reflectivities according to an embodiment of the disclosure. FIG. 10 is a view illustrating irradiation of a laser L according to a selective etching process S4 on a housing 300 according to an embodiment of the disclosure. FIGS. 11 and 12 are photos illustrating the difference between a first area 300a and a second area 300b of a housing 300 according to an embodiment of the disclosure. FIG. 13 illustrates an experimental example of laser L irradiation according to a selective etching process S4 on a second area 300b of a housing 300 and an enlarged cross-sectional photo according to an embodiment of the disclosure. FIG. 14 is a cross-sectional photo illustrating the difference between a first area 300a and a second area 300b of a housing 300 according to an embodiment of the disclosure.

According to an embodiment, a method of processing a housing 300 including a first area 300a and a second area 300b having different reflectivities may include a first vapor deposition process S1 forming a first optical coating layer 330 on a substrate 320, a second vapor deposition process S2 forming a photon absorption layer 340 on the first optical coating layer 330, a third vapor deposition process S3 forming a second optical coating layer 350 on the photon absorption layer 340, and a selective etching process S4 removing the photon absorption layer 340 and the second optical coating layer 350 from the second area 300b of the housing 300.

According to an embodiment, the deposition process may be defined as a process of coating metal particles in a gaseous state as a thin solid film of several micrometers on the surface of an object. For example, it may be a method of designing an optical structure to reach a specific color or specific reflectivity (gloss) through the effect of overlapping (or canceling, reinforcing) between components having different optical paths, where light transmits or reflects through the film according to the components and/or bands of light in the process of passing through the interface of each layer constituting the transparent housing for light.

According to an embodiment, the vapor deposition method may be divided into chemical vapor deposition (CVD) and physical vapor deposition (PVD). According to an embodiment, the first vapor deposition process S1, the second vapor deposition process S2, and the third vapor deposition process S3 may be at least one process of chemical vapor deposition (CVD) or physical vapor deposition (PVD). Chemical vapor deposition (CVD) may be defined as a method of forming a metal thin film by applying heat or plasmatizing a gaseous metal source and a gas that reacts with it to form highly reactive radicals and causing a chemical reaction on a high-temperature substrate (e.g., the substrate 320). Physical vapor deposition (PVD) may be defined as a method where energy applied to a desired metal material is converted to kinetic energy, causing the material to move and accumulate on a substrate (e.g., the substrate 320) to form a thin film.

According to an embodiment, the first vapor deposition process S1 may be designed to form a coating thin film on the surface of the substrate 320 by alternately depositing vaporized first material (e.g., 331 of FIG. 7) or second material (e.g., 332 of FIG. 7) by generating plasma by injecting an inert gas (e.g., Ar) in a vacuum state and then applying a first voltage suitable for the first material (e.g., 331 of FIG. 7) or the second material (e.g., 332 of FIG. 7) to form the first optical coating layer 330 on the substrate 320.

According to an embodiment, the second vapor deposition process S2 may be designed to form a coating thin film on the surface of the first optical coating layer 330 by alternately depositing materials constituting the vaporized photon absorption layer 340 by generating plasma by injecting an inert gas (e.g., Ar) in a vacuum state and then applying a second voltage suitable for the photon absorption layer 340 to form the photon absorption layer 340 on the first optical coating layer 330.

According to an embodiment, the third vapor deposition process S3 may be designed to form a coating thin film on the surface of the photon absorption layer by alternately depositing vaporized third material (e.g., 351 of FIG. 7) or fourth material (e.g., 352 of FIG. 7) by generating plasma by injecting an inert gas (e.g., Ar) in a vacuum state and then applying a third voltage suitable for the third material (e.g., 351 of FIG. 7) or the fourth material (e.g., 352 of FIG. 7) to form the second optical coating layer 350 on the photon absorption layer 340.

According to an embodiment, in the selective etching process S4, when beam energy (kinetic energy of photons) generated by a laser reaches the photon absorption layer 340, electrons in the photon absorption layer 340 are excited by the photon kinetic energy (electrons' energy level moves from the valence band to the conduction band), causing instantaneous heating/volume expansion, and subsequently releasing thermal energy/cooling as they transition to a lower energy level. Through this thermal shock process, the photon absorption layer 340 may be separated from the adjacent first optical coating layer 330 at the interface, and may be selectively detached together with the second optical coating layer 350 forming the external surface starting from the photon absorption layer 340. Equipment that may provide beam energy for selectively delaminating at least a portion of the housing 300 may include an exposure machine and a metal mask, or equipment using ultraviolet (UV) or green band lasers.

According to an embodiment, the photon absorption layer 340 may be formed of a material suitable for the vapor deposition method. According to an embodiment, the photon absorption layer 340 may be formed of a material having an energy band gap lower than the photon kinetic energy of the ultraviolet band (e.g., bands of 400 nm or less). For example, when the energy level of photons in the ultraviolet band (e.g., bands of 400 nm or less) is 3.0995 electron volts (eV), the energy band gap of the photon absorption layer 340 formed by vapor deposition may be 1.12 eV or 1.68 eV, which is lower than the energy level of photons. Accordingly, the photon absorption layer 340 may be considered suitable for inducing electron excitation reactions. An electron excitation reaction may be defined as a reaction in which electrons surrounding an atom transition to a higher energy level by absorbing photons.

According to an embodiment, in areas where photon kinetic energy of a specific wavelength is radiated in the second area 300b, the second optical coating layer 350 and the photon absorption layer 340 are selectively detached, so that the unique reflectivity and color of only the first optical coating layer 330 are formed, enabling implementation of a housing having selective reflectivity.

According to an embodiment, referring to FIG. 11, it may be identified that the color of the first area 300a appears brown or gray, and the color of the second area 300b appears white. According to an embodiment, referring to FIG. 12, it may be identified that the color of the first area 300a appears blue, and the color of the second area 300b appears yellow.

According to an embodiment, referring to FIGS. 13 and 14, a housing sample 30 corresponding to the housing 300 may include a first area sample 30a corresponding to the first area 300a, and a second area sample 30b corresponding to the second area 300b radiated with laser L beam energy. The first area sample 30a may include a substrate sample 32, a first optical coating layer sample 33, a photon absorption layer sample 34, and a second optical coating layer sample 35. The second area sample 30b may include a substrate sample 32 and a first optical coating layer sample 33, and the photon absorption layer sample 34 and the second optical coating layer sample 35 may be removed by laser beam energy. The second area sample 30b partially delaminated by laser beam energy irradiation may be colored red due to the optical characteristics of the first optical coating layer sample 33. The first area sample 30a may be colored aqua due to the optical characteristics of the first optical coating layer sample 33 and the second optical coating layer sample 35.

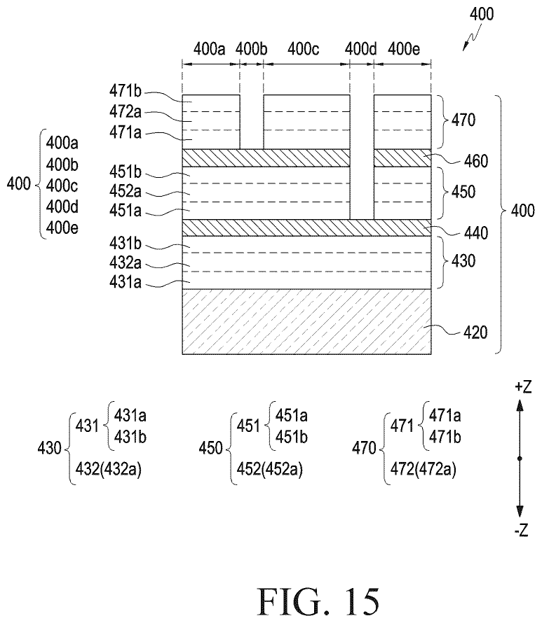

FIG. 15 is a cross-sectional view illustrating at least a portion of a housing 400 according to an embodiment of the disclosure.

Referring to FIG. 15, a housing 400 of an electronic device 101 may include a substrate 420, a first optical coating layer 430, a first photon absorption layer 440, a second optical coating layer 450, a second photon absorption layer 460, and a third optical coating layer 470. The configuration of the housing 400 of FIG. 15 may be identical in whole or portion to the configuration of the housing 300 of FIGS. 5 to 14. The structure of FIG. 15 may be selectively combinable with the structures of FIGS. 5 to 14.

According to an embodiment, the housing 400 may include a first optical coating layer 430, a second optical coating layer 450, and a third optical coating layer 470 disposed on a substrate 420. According to an embodiment, the first optical coating layer 430, the second optical coating layer 450, and the third optical coating layer 470 may be formed by alternately stacking two different materials having different refractive indices. The optical characteristics of the first optical coating layer 430, the second optical coating layer 450, and the third optical coating layer 470 may appear externally as reflection or hue manifested as constructive or destructive interference phenomena of wavelengths due to the difference in refractive index between different materials in the process of light incident from outside passing through the housing 400 including the optical coating structure according to the disclosure. According to an embodiment, the first optical coating layer 430, the second optical coating layer 450, and the third optical coating layer 470 may be transparent materials to allow light to pass through. According to an embodiment, the first optical coating layer 430, the second optical coating layer 450, and the third optical coating layer 470 may be manufactured by a deposition method.

According to an embodiment, the housing 400 according to the disclosure may include photon absorption layers 440, 460 to facilitate functionally and/or design-wise selective delamination and/or removal of at least a portion of the first optical coating layer 430, the second optical coating layer 450, and the third optical coating layer 470. The first photon absorption layer 440 may be disposed between the first optical coating layer 430 and the second optical coating layer 450. The second photon absorption layer 460 may be disposed between the second optical coating layer 450 and the third optical coating layer 470.

According to an embodiment, the housing 400 according to the disclosure may be formed to have two or more optical characteristics (e.g., reflectivity, color). According to an embodiment, the housing 400 may include first areas 400a, 400c, 400e having a first reflectivity, a second area 400b having a second reflectivity different from the first reflectivity, and a third area 400d having a third reflectivity different from the first reflectivity and the second reflectivity. This is to configure an aesthetically beautiful housing 400 through two or more optical interference effects by implementing the housing 400 having two or more reflectivities.

According to an embodiment, the first areas 400a, 400c, 400e may be formed by stacking the above-described substrate 420, the first optical coating layer 430, the first photon absorption layer 440, the second optical coating layer 450, the second photon absorption layer 460, and the third optical coating layer 470. According to an embodiment, the second area 400b may be an area where at least a portion of the housing 400 included in the first areas 400a, 400c, 400e is removed. For example, the second area 400b may include the above-described substrate 420, the first optical coating layer 430, the first photon absorption layer 440, and the second optical coating layer 450, and the second photon absorption layer 460 and the third optical coating layer 470 may be removed. According to an embodiment, the third area 400d may be an area where at least a portion of the housing 400 included in the first areas 400a, 400c, 400e is removed. For example, the third area 400d may be composed of the above-described substrate 420 and the first optical coating layer 430, and the first photon absorption layer 440, the second optical coating layer 450, the second photon absorption layer 460, and the third optical coating layer 470 may be removed.

According to an embodiment, the first optical coating layer 430 may be formed by alternately stacking two different materials having different refractive indices. For example, the first optical coating layer 430 may be formed by alternately stacking a first material 431 having a first refractive index and a second material 432 having a second refractive index different from the first refractive index. For example, the first optical coating layer 430 may include a first material 431a having a first refractive index, a second material 432a having a second refractive index disposed on the first material 431a, and a first material 431b disposed on the second material 432a. For example, the first refractive index and the second refractive index may be about greater than or equal to 1.3 and less than or equal to 3.0. For example, the first refractive index may differ from the second refractive index by about 0.1 or more. For example, the first refractive index may be designed to be about 0.4 or more lower than the second refractive index. The optical characteristics of the first optical coating layer 430 may appear externally as reflection or hue manifested as constructive or destructive interference phenomena of wavelengths due to the difference in refractive index between different materials in the process of light incident from outside passing through the housing 400 including the optical coating structure according to the disclosure.

According to an embodiment, the second optical coating layer 450 may be formed by alternately stacking two different materials having different refractive indices. For example, the second optical coating layer 450 may be formed by alternately stacking a third material 451 having a third refractive index and a fourth material 452 having a fourth refractive index different from the third refractive index. For example, the second optical coating layer 450 may include a third material 451a having a third refractive index, a fourth material 452a having a fourth refractive index disposed on the third material 451a, and a third material 451b disposed on the fourth material 452a. For example, the third refractive index and the fourth refractive index may be about greater than or equal to 1.3 and less than or equal to 3.0. For example, the third refractive index may differ from the fourth refractive index by about 0.1 or more. For example, the third refractive index may be designed to be about 0.4 or more lower than the fourth refractive index. The optical characteristics of the second optical coating layer 450 may appear externally as reflection or hue manifested as constructive or destructive interference phenomena of wavelengths due to the difference in refractive index between different materials in the process of light incident from outside passing through the housing 400 including the optical coating structure according to the disclosure.

According to an embodiment, the third optical coating layer 470 may be formed by alternately stacking two different materials having different refractive indices. For example, the third optical coating layer 470 may be formed by alternately stacking a fifth material 471 having a fifth refractive index and a sixth material 472 having a sixth refractive index different from the fifth refractive index. For example, the third optical coating layer 470 may include a fifth material 471a having a fifth refractive index, a sixth material 472a having a sixth refractive index disposed on the fifth material 471a, and a fifth material 471b disposed on the sixth material 472a. For example, the fifth refractive index and the sixth refractive index may be about greater than or equal to 1.3 and less than or equal to 3.0. For example, the fifth refractive index may differ from the sixth refractive index by about 0.1 or more. For example, the fifth refractive index may be designed to be about 0.4 or more lower than the sixth refractive index. The optical characteristics of the third optical coating layer 470 may appear externally as reflection or hue manifested as constructive or destructive interference phenomena of wavelengths due to the difference in refractive index between different materials in the process of light incident from outside passing through the housing 400 including the optical coating structure according to the disclosure.

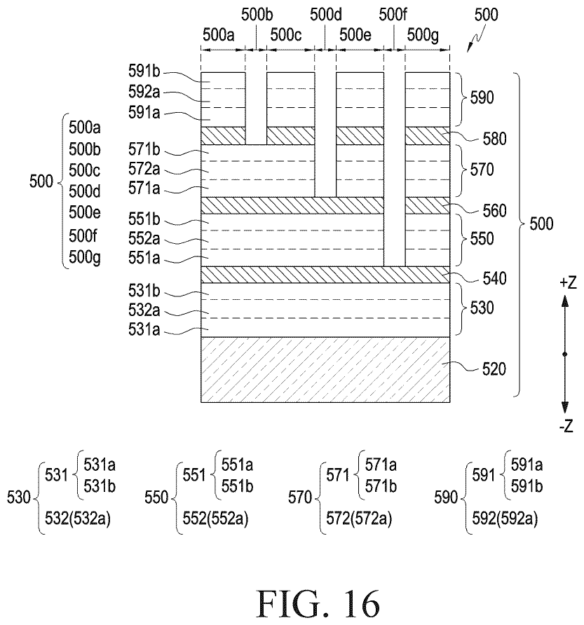

FIG. 16 is a cross-sectional view illustrating at least a portion of a housing 500 according to an embodiment of the disclosure.

Referring to FIG. 16, a housing 500 of an electronic device 101 may include a substrate 520, a first optical coating layer 530, a first photon absorption layer 540, a second optical coating layer 550, a second photon absorption layer 560, a third optical coating layer 570, a third photon absorption layer 580, and a fourth optical coating layer 590. The configuration of the housing 500 of FIG. 16 may be identical in whole or portion to the configuration of the housing 300 of FIGS. 5 to 15. The structure of FIG. 16 may be selectively combinable with the structures of FIGS. 5 to 15.

According to an embodiment, the housing 500 may include a first optical coating layer 530, a second optical coating layer 550, a third optical coating layer 570, and a fourth optical coating layer 590 disposed on a substrate 520. According to an embodiment, the first optical coating layer 530, the second optical coating layer 550, the third optical coating layer 570, and the fourth optical coating layer 590 may be formed by alternately stacking two different materials having different refractive indices. The optical characteristics of the first optical coating layer 530, the second optical coating layer 550, the third optical coating layer 570, and the fourth optical coating layer 590 may appear externally as reflection or hue manifested as constructive or destructive interference phenomena of wavelengths due to the difference in refractive index between different materials in the process of light incident from outside passing through the housing 500 including the optical coating structure according to the disclosure. According to an embodiment, the first optical coating layer 530, the second optical coating layer 550, the third optical coating layer 570, and the fourth optical coating layer 590 may be transparent materials to allow light to pass through. According to an embodiment, the first optical coating layer 530, the second optical coating layer 550, the third optical coating layer 570, and the fourth optical coating layer 590 may be manufactured by a deposition method.

According to an embodiment, the housing 500 according to the disclosure may include photon absorption layers 540, 560, 580 to facilitate functionally and/or design-wise selective delamination and/or removal of at least a portion of the first optical coating layer 530, the second optical coating layer 550, the third optical coating layer 570, and the fourth optical coating layer 590. The first photon absorption layer 540 may be disposed between the first optical coating layer 530 and the second optical coating layer 550. The second photon absorption layer 560 may be disposed between the second optical coating layer 550 and the third optical coating layer 570. The third photon absorption layer 580 may be disposed between the third optical coating layer 570 and the fourth optical coating layer 590.

According to an embodiment, the housing 500 according to the disclosure may be formed to have two or more optical characteristics (e.g., reflectivity, color). According to an embodiment, the housing 500 may include first areas 500a, 500c, 500e, 500g having a first reflectivity, a second area 500b having a second reflectivity different from the first reflectivity, a third area 500d having a third reflectivity different from the first reflectivity and the second reflectivity, and a fourth area 500f having a fourth reflectivity different from the first reflectivity, the second reflectivity, and the third reflectivity. This is to configure an aesthetically beautiful housing 500 through two or more optical interference effects by implementing the housing 500 having two or more reflectivities.

According to an embodiment, the first areas 500a, 500c, 500e, 500g may be formed by stacking the above-described substrate 520, the first optical coating layer 530, the first photon absorption layer 540, the second optical coating layer 550, the second photon absorption layer 560, the third optical coating layer 570, the third photon absorption layer 580 and the fourth optical coating layer 590. According to an embodiment, the second area 500b may be an area where at least a portion of the housing 500 included in the first areas 500a, 500c, 500e, 500g is removed. For example, the second area 500b may include the above-described substrate 520, the first optical coating layer 530, the first photon absorption layer 540, the second optical coating layer 550, the second photon absorption layer 560, and the third optical coating layer 570, and the third photon absorption layer 580 and the fourth optical coating layer 590 may be removed. According to an embodiment, the third area 500d may be an area where at least a portion of the housing 500 included in the first areas 500a, 500c, 500e, 500g is removed. For example, the third area 500d may include the above-described substrate 520, the first optical coating layer 530, the first photon absorption layer 540, and the second optical coating layer 550, and the second photon absorption layer 560, the third optical coating layer 570, the third photon absorption layer 580, and the fourth optical coating layer 590 may be removed. According to an embodiment, the fourth area 500f may be an area where at least a portion of the housing 500 included in the first areas 500a, 500c, 500e, 500g is removed. For example, the fourth area 500f may include the above-described substrate 520 and the first optical coating layer 530, and the first photon absorption layer 540, the second optical coating layer 550, the second photon absorption layer 560, the third optical coating layer 570, the third photon absorption layer 580, and the fourth optical coating layer 590 may be removed.

According to an embodiment, the first optical coating layer 530 may be formed by alternately stacking two different materials having different refractive indices. For example, the first optical coating layer 530 may be formed by alternately stacking a first material 531 having a first refractive index and a second material 532 having a second refractive index different from the first refractive index. For example, the first optical coating layer 530 may include a first material 531a having a first refractive index, a second material 532a having a second refractive index disposed on the first material 531a, and a first material 531b disposed on the second material 532a. For example, the first refractive index and the second refractive index may be about greater than or equal to 1.3 and less than or equal to 3.0. For example, the first refractive index may differ from the second refractive index by about 0.1 or more. For example, the first refractive index may be designed to be about 0.5 or more lower than the second refractive index. The optical characteristics of the first optical coating layer 530 may appear externally as reflection or hue manifested as constructive or destructive interference phenomena of wavelengths due to the difference in refractive index between different materials in the process of light incident from outside passing through the housing 500 including the optical coating structure according to the disclosure.

According to an embodiment, the second optical coating layer 550 may be formed by alternately stacking two different materials having different refractive indices. For example, the second optical coating layer 550 may be formed by alternately stacking a third material 551 having a third refractive index and a fifth material 552 having a fifth refractive index different from the third refractive index. For example, the second optical coating layer 550 may include a third material 551a having a third refractive index, a fifth material 552a having a fifth refractive index disposed on the third material 551a, and a third material 551b disposed on the fifth material 552a. For example, the third refractive index and the fifth refractive index may be about greater than or equal to 1.3 and less than or equal to 3.0. For example, the third refractive index may differ from the fifth refractive index by about 0.1 or more. For example, the third refractive index may be designed to be about 0.5 or more lower than the fifth refractive index. The optical characteristics of the second optical coating layer 550 may appear externally as reflection or hue manifested as constructive or destructive interference phenomena of wavelengths due to the difference in refractive index between different materials in the process of light incident from outside passing through the housing 500 including the optical coating structure according to the disclosure.

According to an embodiment, the third optical coating layer 570 may be formed by alternately stacking two different materials having different refractive indices. For example, the third optical coating layer 570 may be formed by alternately stacking a fifth material 571 having a fifth refractive index and a sixth material 572 having a sixth refractive index different from the fifth refractive index. For example, the third optical coating layer 570 may include a fifth material 571a having a fifth refractive index, a sixth material 572a having a sixth refractive index disposed on the fifth material 571a, and a fifth material 571b disposed on the sixth material 572a. For example, the fifth refractive index and the sixth refractive index may be about greater than or equal to 1.3 and less than or equal to 3.0. For example, the fifth refractive index may differ from the sixth refractive index by about 0.1 or more. For example, the fifth refractive index may be designed to be about 0.5 or more lower than the sixth refractive index. The optical characteristics of the third optical coating layer 570 may appear externally as reflection or hue manifested as constructive or destructive interference phenomena of wavelengths due to the difference in refractive index between different materials in the process of light incident from outside passing through the housing 500 including the optical coating structure according to the disclosure.

According to an embodiment, the fourth optical coating layer 590 may be formed by alternately stacking two different materials having different refractive indices. For example, the fourth optical coating layer 590 may be formed by alternately stacking a seventh material 591 having a seventh refractive index and an eighth material 592 having an eighth refractive index different from the seventh refractive index. For example, the fourth optical coating layer 590 may include a seventh material 591a having a seventh refractive index, an eighth material 592a having an eighth refractive index disposed on the seventh material 591a, and a seventh material 591b disposed on the eighth material 592a. For example, the seventh refractive index and the eighth refractive index may be about greater than or equal to 1.3 and less than or equal to 3.0. For example, the seventh refractive index may differ from the eighth refractive index by about 0.1 or more. For example, the seventh refractive index may be designed to be about 0.5 or more lower than the eighth refractive index. The optical characteristics of the fourth optical coating layer 590 may appear externally as reflection or hue manifested as constructive or destructive interference phenomena of wavelengths due to the difference in refractive index between different materials in the process of light incident from outside passing through the housing 500 including the optical coating structure according to the disclosure.

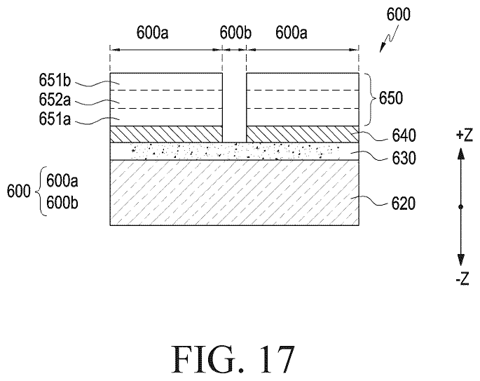

FIG. 17 is a cross-sectional view illustrating at least a portion of a housing 600 according to an embodiment of the disclosure.

Referring to FIG. 17, a housing 600 of an electronic device 101 may include a substrate 620, a silicon dioxide (SiO2) layer 630, a photon absorption layer 640, and a first optical coating layer 650. The configuration of the housing 600 of FIG. 17 may be identical in whole or portion to the configuration of the housing 300 of FIGS. 5 to 16. The structure of FIG. 17 may be selectively combinable with the structures of FIGS. 5 to 16.

According to an embodiment, the housing 600 may include a first optical coating layer 650 disposed on the substrate 620. According to an embodiment, the first optical coating layer 650 may be formed by alternately stacking two different materials having different refractive indices. The optical characteristics of the first optical coating layer 650 may appear externally as reflection or hue manifested as constructive or destructive interference phenomena of wavelengths due to the difference in refractive index between different materials in the process of light incident from outside passing through the housing 600 including the optical coating structure according to the disclosure. According to an embodiment, the first optical coating layer 650 may be a transparent material to allow light to pass through. According to an embodiment, the first optical coating layer 650 may be manufactured by a deposition method.

According to an embodiment, the housing 600 according to the disclosure may include a photon absorption layer 640 to facilitate functionally and/or design-wise selective delamination and/or removal of at least a portion of the silicon dioxide (SiO2) layer 630 and the first optical coating layer 650. The photon absorption layer 640 may be disposed between the silicon dioxide (SiO2) layer 630 and the first optical coating layer 650.

According to an embodiment, the housing 600 according to the disclosure may be formed to have two or more optical characteristics (e.g., reflectivity, color). According to an embodiment, the housing 600 may include a first area 600a having a first reflectivity and a second area 600b having a second reflectivity different from the first reflectivity. This is to configure an aesthetically beautiful housing 600 through two or more optical interference effects by implementing the housing 600 having two or more reflectivities.

According to an embodiment, the first area 600a may be formed by stacking the above-described substrate 620, silicon dioxide (SiO2) layer 630, photon absorption layer 640, and first optical coating layer 650. According to an embodiment, the second area 600b may be an area where at least a portion of the housing 600 included in the first area 600a is removed. For example, the second area 600b may be composed of the above-described substrate 620 and silicon dioxide (SiO2) layer 630, and the photon absorption layer 640 and the first optical coating layer 650 may be removed.

According to an embodiment, the first optical coating layer 650 may be formed by alternately stacking two different materials having different refractive indices. For example, the first optical coating layer 650 may be formed by alternately stacking a first material 651 having a first refractive index and a second material 652 having a second refractive index different from the first refractive index. For example, the first optical coating layer 650 may include a first material 651a having a first refractive index, a second material 652a having a second refractive index disposed on the first material 651a, and a first material 651b disposed on the second material 652a. For example, the first refractive index and the second refractive index may be about greater than or equal to 1.3 and less than or equal to 3.0. For example, the first refractive index may differ from the second refractive index by about 0.1 or more. For example, the first refractive index may be designed to be about 0.6 or more lower than the second refractive index. The optical characteristics of the first optical coating layer 650 may appear externally as reflection or hue manifested as constructive or destructive interference phenomena of wavelengths due to the difference in refractive index between different materials in the process of light incident from outside passing through the housing 600 including the optical coating structure according to the disclosure.

An electronic device including a housing according to an embodiment of the disclosure may include the housing having a first area 300a having a first reflectivity and a second area 300b having a second reflectivity different from the first reflectivity, the first area including a substrate 320, a first optical coating layer 330 disposed on the substrate, a photon absorption layer 340 disposed on the first optical coating layer, and a second optical coating layer 350 disposed on the photon absorption layer, the second area including the substrate and the first optical coating layer, the first optical coating layer configured such that a first material having a first refractive index and a second material having a second refractive index different from the first refractive index are alternately stacked, and the second optical coating layer configured such that a third material having a third refractive index and a fourth material having a fourth refractive index different from the third refractive index are alternately stacked.

According to an embodiment, the photon absorption layer may include at least one of silicon and aluminum.

According to an embodiment, an extinction coefficient (k) of a material constituting the photon absorption layer may be greater than or equal to 0.01 and less than or equal to 0.5.

According to an embodiment, a thickness of the photon absorption layer may be greater than or equal to 10nm and less than or equal to 500 nm.

According to an embodiment, the first reflectivity may be greater than or equal to 10%, and the second reflectivity may be formed to be greater than the first reflectivity by 2% or more.

According to an embodiment, the first area may have a first color, and the second area may have a second color different from the first color, the first color may have a color coordinate value of 2 or more, and the second color may be formed to have a color coordinate value greater than the color coordinate value of the first color by 2 or more.

According to an embodiment, the first refractive index may be lower than the second refractive index by 0.1 or more.

According to an embodiment, the third refractive index may be lower than the fourth refractive index by 0.1 or more.

According to an embodiment, the first refractive index, the second refractive index, the third refractive index, and the fourth refractive index may be greater than or equal to 1.3 and less than or equal to 3.0.

According to an embodiment, the housing may further include a base film 310 disposed below the substrate.

According to an embodiment, the housing may further include a first protective coating layer disposed on the second optical coating layer and configured to protect the housing from external impact, and a second protective coating layer disposed on the first protective coating layer and including contamination-resistant and scratch-resistant material.

An electronic device including a housing according to an embodiment of the disclosure may include the housing having a substrate 320, a plurality of optical coating layers 330, 350 including a first optical coating layer 330 disposed on the substrate and a second optical coating layer 350 formed on the first optical coating layer, and a photon absorption layer 340 disposed between the first optical coating layer 330 and the second optical coating layer 350, the housing including a first area 300a including the substrate, the first optical coating layer, the photon absorption layer, and the second optical coating layer and having a first reflectivity, and a second area 300b excluding at least a portion from the first area and having a second reflectivity different from the first reflectivity.

According to an embodiment, the first optical coating layer may be formed by alternately stacking a first material having a first refractive index and a second material having a second refractive index different from the first refractive index, and the second optical coating layer may be formed by alternately stacking a third material having a third refractive index and a fourth material having a fourth refractive index different from the third refractive index.

According to an embodiment, the second area may include only of the substrate and the first optical coating layer.

According to an embodiment, a thickness of the photon absorption layer may be greater than or equal to 10 nm and less than or equal to 500 nm.

According to an embodiment, the first reflectivity may be greater than or equal to 10%, and the second reflectivity may be formed to be greater than the first reflectivity by 2% or more.

According to an embodiment, the first area may have a first color, and the second area may have a second color different from the first color, the first color may have a color coordinate value of 2 or more, and the second color may be formed to have a color coordinate value greater than the color coordinate value of the first color by 2 or more.

According to an embodiment, the first refractive index may be lower than the second refractive index by 0.1 or more.

According to an embodiment, the third refractive index may be lower than the fourth refractive index by 0.1 or more.

A method of processing a housing 300 including a first area 300a and a second area 300b having different reflectivities according to an embodiment of the disclosure may include a first vapor deposition process S1 forming a first optical coating layer 330 on a substrate 320, a second vapor deposition process S2 forming a photon absorption layer 340 on the first optical coating layer, a third vapor deposition process S3 forming a second optical coating layer 350 on the photon absorption layer, and a selective etching process S4 removing the photon absorption layer and the second optical coating layer from the second area of the housing, wherein the selective etching process may radiate a laser of a specific wavelength to the second area 300b.

Generally, to implement a coating layer having selective reflectivity in a housing of an electronic device, a chemical etching method and a delamination method using laser etching may be applied to the optical coating layer. The chemical etching method may lose the optical interference effect unique to the coating if the glass substrate is corroded simultaneously or the optical coating layer is lost. The laser etching method may have minimal etching effect if the laser passes through without reaction due to the optical transparency of the coating thin film.

An electronic device according to an embodiment of the disclosure may provide an aesthetically beautiful electronic device by implementing a housing having two or more reflectivities by selectively changing the reflectivity of the housing constituting the exterior.

An electronic device according to an embodiment of the disclosure includes a housing composed of two optical coating layers and a photon absorption layer disposed between the two optical coating layers, where the overall reflection and hue of the optical coating are implemented by overlapping the two optical coating layers and, when light of a specific wavelength is radiated, the second optical coating layer and the photon absorption layer are removed only in the second area of the housing, resulting in the unique reflection and hue of only the first optical coating layer, thereby implementing optical coating having selective reflectivity.

1. An electronic device comprising a housing,
wherein the housing comprises a first area having a first reflectivity, and a second area having a second reflectivity different from the first reflectivity,
wherein the first area comprises:
a substrate;
a first optical coating layer disposed on the substrate;
a photon absorption layer disposed on the first optical coating layer; and
a second optical coating layer disposed on the photon absorption layer,
wherein the second area comprises:
the substrate; and
the first optical coating layer,
wherein the first optical coating layer is configured such that a first material having a first refractive index and a second material having a second refractive index different from the first refractive index are alternately stacked, and
wherein the second optical coating layer is configured such that a third material having a third refractive index and a fourth material having a fourth refractive index different from the third refractive index are alternately stacked.

2. The electronic device of claim 1, wherein the photon absorption layer comprises at least one of silicon and aluminum.

3. The electronic device of claim 1, wherein an extinction coefficient of a material constituting the photon absorption layer is greater than or equal to 0.01 and less than or equal to 0.5.

4. The electronic device claim 1, wherein a thickness of the photon absorption layer is greater than or equal to 10 nanometers and less than or equal to 500 nanometers.

5. The electronic device claim 1, wherein the first reflectivity is greater than or equal to 10%, and the second reflectivity is formed to be greater than the first reflectivity by 2% or more.

6. The electronic device claim 1, wherein the first area has a first color, and the second area has a second color different from the first color, wherein the first color has a color coordinate value of 2 or more, and the second color is formed to have a color coordinate value greater than the color coordinate value of 2 or more of the first color by 2 or more.

7. The electronic device claim 1, wherein the first refractive index is lower than the second refractive index by 0.1 or more.

8. The electronic device claim 1, wherein the third refractive index is lower than the fourth refractive index by 0.1 or more.

9. The electronic device claim 1, wherein the first refractive index, the second refractive index, the third refractive index, and the fourth refractive index are greater than or equal to 1.3 and less than or equal to 3.0.

10. The electronic device claim 1, wherein the housing further comprises a base film disposed below the substrate.

11. The electronic device claim 1, wherein the housing further comprises:
a first protective coating layer disposed on the second optical coating layer and configured to protect the housing from external impact; and
a second protective coating layer disposed on the first protective coating layer and comprising a contamination-resistant and scratch-resistant material.

12. A method of processing a housing comprising a first area and a second area having different reflectivities, wherein the method comprises:
a first vapor deposition process forming a first optical coating layer on a substrate;
a second vapor deposition process forming a photon absorption layer on the first optical coating layer;
a third vapor deposition process forming a second optical coating layer on the photon absorption layer; and
a selective etching process removing the photon absorption layer and the second optical coating layer from the second area of the housing,
wherein the selective etching process radiates a laser having a specific wavelength to the second area.

13. An electronic device comprising a housing,
wherein the housing comprises,
a substrate;
a plurality of optical coating layers, including a first optical coating layer disposed on the substrate and a second coating layer formed on the first optical coating layer
a photon absorption layer disposed between the first optical coating layer and the second coating layer;
wherein a first area, of the housing has a first reflectivity and includes the substrate, the first optical coating layer, the second coating layer and the photon absorption layer; and
wherein a second area, of the housing has a second reflectivity different from the first reflectivity and includes the substrate, the first optical coating layer, and the second coating layer.

14. The electronic device of claim 13,
wherein the first optical coating layer is configured such that a first material having a first refractive index and a second material having a second refractive index different from the first refractive index are alternately stacked, and
wherein the second optical coating layer is configured such that a third material having a third refractive index and a fourth material having a fourth refractive index different from the third refractive index are alternately stacked.

15. The electronic device of claim 13,
wherein the photon absorption layer comprises at least one of silicon and aluminum.

16. The electronic device of claim 13,
wherein a thickness of the photon absorption layer is greater than or equal to 10 nanometers and less than or equal to 500 nanometers.

17. The electronic device of claim 13,
wherein the first reflectivity is greater than or equal to 10%, and the second reflectivity is formed to be greater than the first reflectivity by 2% or more.

18. The electronic device of claim 13,
wherein the first area has a first color, and the second area has a second color different from the first color,
wherein the first color has a color coordinate value of 2 or more, and the second color is formed to have a color coordinate value greater than the color coordinate value of 2 or more of the first color by 2 or more.

19. The electronic device of claim 14,
wherein the first refractive index is lower than the second refractive index by 0.1 or more.

20. The electronic device of claim 14,
wherein the third refractive index is lower than the fourth refractive index by 0.1 or more.
